(19) United States
(12) Patent Application Publication
(10) Pub. No.: US 2025/0323398 A1
(43) Pub. Date: Oct. 16, 2025

(54) SECONDARY BATTERY

(71) Applicant: Prime Planet Energy & Solutions, Inc., Tokyo (JP)

(72) Inventors: Yozo UCHIDA, Toyota-shi (JP); Satoshi FUJIMURA, Toki-shi (JP)

(21) Appl. No.: 19/055,497

(22) Filed: Feb. 18, 2025

(30) Foreign Application Priority Data
Apr. 11, 2024 (JP) 2024-063933

(51) Int. Cl. H01M 50/581; H01M 10/42; H01M 50/193; H01M 50/198; H01M 50/559

(52) U.S. Cl. CPC H01M 50/581; H01M 10/4235; H01M 50/193; H01M 50/198; H01M 50/559; H01M 2200/10

(57) ABSTRACT

A secondary battery includes a battery case, an electrode body housed in the battery case, and a current collector terminal including an outer terminal inserted in a terminal through hole of the battery case and fixed to the battery case via an insulating resin member and an inner terminal formed to be energized to the outer terminal and connected to the electrode body. The current collector terminal is provided with a current interrupt mechanism configured such that when the battery temperature rises above a predetermined temperature, the outer terminal and the inner terminal are separated by the biasing force of a spring member biasing the outer terminal or/and the inner terminal and placed into a de-energized state.

### CROSS-REFERENCE TO RELATED APPLICATIONS

This application is based upon and claims the benefit of priority to Japanese Patent Application No. 2024-063933 filed on Apr. 11, 2024, the entire contents of which are incorporated herein by reference.

### BACKGROUND

### Technical Field

The disclosure relates to a secondary battery.

### Related Art

In general, when a sealed secondary battery is charged at high voltages or high currents, gas may be generated in the battery, causing an increase in internal battery pressure and a rise in battery temperature (i.e., the temperature of the battery). Therefore, for example, Japanese unexamined patent application publication No. 2020-064717 (JP 2020-064717A) discloses a non-aqueous electrolyte secondary battery in which the composition of positive active material, the components of electrolyte, and others are specified to increase the amount of gas to be generated during overcharging to facilitate the activation of a pressure-activated current interrupt mechanism provided in a battery case.

### SUMMARY

### Technical Problems

In the above-described secondary battery, however, the current interrupt mechanism does not operate until the gas pressure in the battery rises above a predetermined value. This causes a delay in current interrupt when the battery temperature rises rapidly due to a short circuit in an electrode body, for example.

The present disclosure has been made to address the above problems and has a purpose to provide a highly safe secondary battery provided with a current interrupt mechanism capable of quickly interrupting currents as the battery temperature rises without waiting for the gas pressure in the battery to rise above a predetermined value when a short circuit or other defects occur in an electrode body.

### Means of Solving the Problems

(1) To achieve the above-mentioned purpose, one aspect of the present disclosure provides a secondary battery comprising: a battery case including a terminal through hole; an electrode body housed in the battery case; and a current collector terminal including: an outer terminal inserted in the terminal through hole of the battery case and fixed to the battery case via an insulating resin member; and an inner terminal connected to the electrode body and formed to be energized to the outer terminal, wherein the current collector terminal is provided with a current interrupt mechanism including a spring member that biases the outer terminal or/and the inner terminal, the current interrupt mechanism being configured such that, when a battery temperature rises above a predetermined temperature, the outer terminal and the inner terminal are separated from each other into a de-energized state by a biasing force of the spring member.

(2) In the secondary battery described in (1), the current interrupt mechanism may be configured such that, when the battery temperature rises above the predetermined temperature and the insulating resin member melts or softens, the outer terminal is caused to move toward battery outside by the biasing force of the spring member, so that the outer terminal and the inner terminal are placed in the de-energized state.

(3) In the secondary battery described in (1), the insulating resin member may be a layered insulating resin member including a low-melting point resin member as an intermediate layer of the insulating resin member, the low-melting point resin member having a lower melting point than a melting point of the insulating resin member, and the outer terminal is fixed to the battery case via the layered insulating resin member, and the current interrupt mechanism may be configured such that, when the low-melting point resin member melts or softens, the outer terminal is caused to move toward battery outside by the biasing force of the spring member, so that the outer terminal and the inner terminal are placed in the de-energized state.

(4) In the secondary battery described in (1), the inner terminal may be fixed to either the battery case or the insulating resin member via a low-melting resin member having a lower melting point than the insulating resin member, and the current interrupt mechanism may be configured such that, when the low-melting resin member melts or softens, the inner terminal is caused to move toward battery inside by the biasing force of the spring member, so that the outer terminal and the inner terminal are placed in the de-energized state.

(5) In the secondary battery described in (1), the inner terminal may be joined to the outer terminal with a low-melting point joining member having a lower melting point than a melting point of the insulating resin member, and the current interrupt mechanism may be configured such that, when the low-melting point joining member melts or softens, the inner terminal is caused to move toward battery inside by the biasing force of the spring member, so that the outer terminal and the inner terminal are placed in the de-energized state.

### BRIEF DESCRIPTION OF THE DRAWINGS

FIG. 1 is a schematic cross-sectional view of a secondary battery according to one form of an embodiment;

FIG. 2 is a schematic perspective view showing a positive electrode and a negative electrode of an electrode body shown in FIG. 1 in the process of being stacked and wound with separators interposed therebetween;

FIG. 3A is an enlarged cross-sectional view of a current interrupt mechanism in a secondary battery of a first example, showing a section A in FIG. 1;

FIG. 3B is an enlarged cross-sectional view showing an activated state of the current interrupt mechanism shown in FIG. 3A;

FIG. 4A is an enlarged cross-sectional view of a current interrupt mechanism in a secondary battery of a second example, showing the section A in FIG. 1;

FIG. 4B is an enlarged cross-sectional view showing an activated state of the current interrupt mechanism shown in FIG. 4A;

FIG. 5A is an enlarged cross-sectional view of a current interrupt mechanism in a secondary battery of a third example, showing the section A in FIG. 1;

FIG. 5B is an enlarged cross-sectional view showing an activated state of the current interrupt mechanism shown in FIG. 5A;

FIG. 6A is an enlarged cross-sectional view of a current interrupt mechanism in a secondary battery of a fourth example, showing the section A in FIG. 1;

FIG. 6B is an enlarged cross-sectional view showing an activated state of the current interrupt mechanism shown in FIG. 6A;

FIG. 7A is an enlarged cross-sectional view of a current interrupt mechanism in a secondary battery of a fifth example, showing the section A in FIG. 1;

FIG. 7B is an enlarged cross-sectional view showing an activated state of the current interrupt mechanism shown in FIG. 7A;

FIG. 8A is an enlarged cross-sectional view of a current interrupt mechanism in a secondary battery of a sixth example according to another form of the embodiment; and

FIG. 8B is an enlarged cross-sectional view showing an activated state of the current interrupt mechanism shown in FIG. 8A.

### DETAILED DESCRIPTION OF THE EXEMPLARY EMBODIMENTS

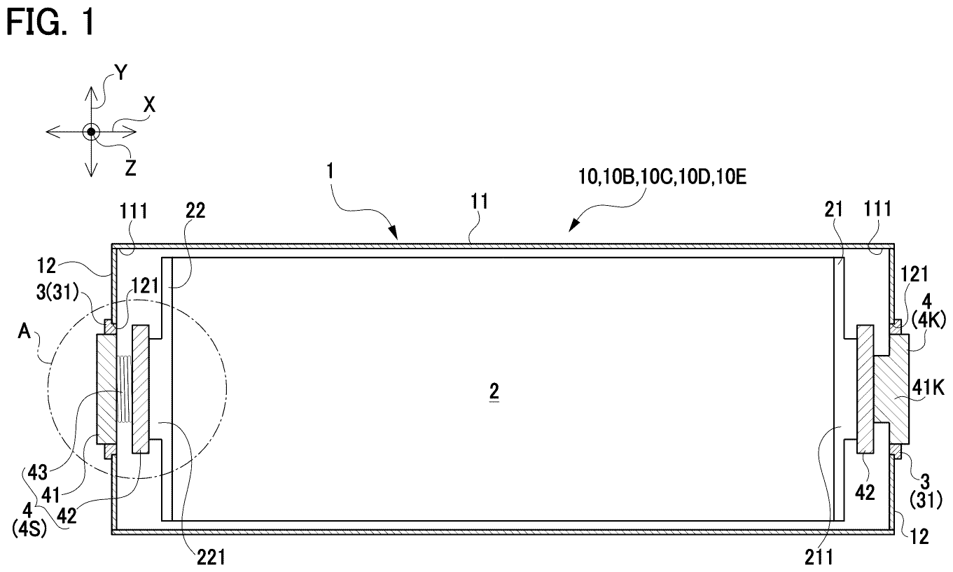

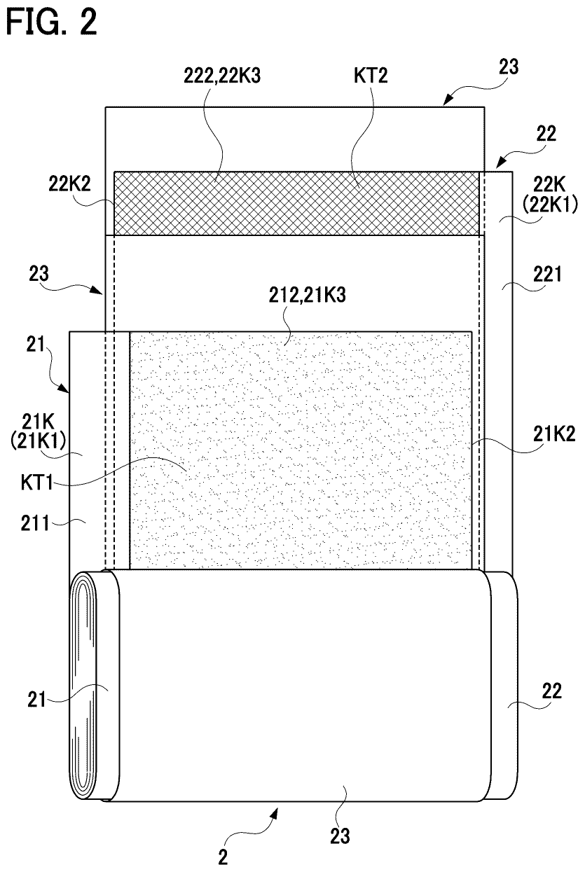

A detailed description of a secondary battery in an embodiment of this disclosure will now be given referring to the accompanying drawings. FIG. 1 is a schematic cross-sectional view of a secondary battery in the embodiment. FIG. 2 is a schematic perspective view showing a positive electrode and a negative electrode of an electrode body shown in FIG. 1 in the process of being stacked and wound with separators interposed therebetween. In FIG. 1, the direction X indicates a long-side direction of a battery case, the direction Y indicates a vertical direction of the battery case, and the direction Z indicates a width direction (i.e., a short-side direction) of the battery case.

A secondary battery 10 in the embodiment includes for example a battery case 1, an electrode body 2 housed in the battery case 1, and current collector terminals 4, as shown in FIGS. 1 and 2. Each current collector terminal 4 includes an outer terminal 41 inserted in a terminal through hole 121 of the battery case 1 and fixed to the battery case 1 via an insulating resin member 31, and an inner terminal 42 to be energized, i.e., electrically conductive, to the outer terminal 41, and connected to the electrode body 2. Further, at least one of the current collector terminals 4 is further provided with a current interrupt mechanism 4S, which includes a spring member 43 biasing the outer terminal 41 or/and the inner terminal 42 and is configured such that, when the battery temperature rises above a predetermined temperature, the outer terminal 41 and the inner terminal 42 are separated from each other and brought into a de-energized state by the biasing force of the spring member 43.

In the secondary battery 10 in the embodiment, the current collector terminal 4 is provided with the current interrupt mechanism 4S to separate the outer terminal 41 and the inner terminal 42 by use of the biasing force of the spring member 43 biasing the outer terminal 41 or/and the inner terminal 42, i.e., at least one of the outer terminal 41 and the inner terminal 42, when the battery temperature rises beyond the predetermined temperature. Thus, when the battery temperature abruptly rises due to a short circuit in the electrode body 2 or other defects, the outer terminal 41 and the inner terminal 42 are separated from each other and put into the de-energized relationship without waiting until the gas pressure in the secondary battery 10 increases above a predetermined value. This enables quick current interrupt as the temperature of the secondary battery 10 rises, resulting in a highly safe secondary battery 10.

In this embodiment, the battery case 1 is provided with a rectangular prismatic case body 11 extending in the long-side direction (i.e., the direction X), and a pair of lid members 12 closing opening portions 111 formed at both ends in the long-side direction (the direction X) of the case body 11, as shown in FIG. 1. Each of the lid members 12 is formed, at a middle part in the vertical direction (i.e., the direction Y), with a terminal through hole 121. In the lid members 12, the outer terminals 41, 41K are inserted in the terminal through holes 121 and fixed via the insulating resin members 31. The insulating resin members 31 may be made of, for example, polyphenylene sulfide (PPS).

One of the lid members 12, which is located on the left side facing a negative electrode 22 in FIG. 1, is attached with the current collector terminal 4 provided with the current interrupt mechanism 4S configured such that when the battery temperature rises above a predetermined temperature, the outer terminal 41 and the inner terminal 42 are separated from each other by the biasing force of the spring member 43 urging the outer terminal 41 or/and the inner terminal 42 and become de-energized. Since one of the current collector terminals 4, which is placed on a negative electrode side with a lower contact resistance than on a positive electrode side, is provided with the current interrupt mechanism 4S, power loss at a terminal contact area can be reduced.

Further, the other lid member 12 located on the right side facing a positive electrode 21 in FIG. 1 is attached with the other current collector terminal 4 that is a fixed terminal 4K formed of an outer terminal 41K and an inner terminal 42 that are fixed. However, for the other lid member 12 located on the right side close to the positive electrode 21 in FIG. 1, the current collector terminal 4 is not limited to the fixed terminal 4K but may be a current collector terminal 4 provided with the current interrupt mechanism 4S, identical to that for the one lid member 12 located on the left side close to the negative electrode 22 in FIG. 1. This is because when each of the current collector terminal 4 on the negative electrode side and the current collector terminal 4 on the positive electrode side is provided with the current interrupt mechanism 4S, quick current interrupt is enabled wherever a short circuit occurs in the electrode body 2.

The battery case 1 is not limited to the above form as long as the inside of the battery case 1 is watertight. For example, a battery case may be provided with a bottomed prismatic case body with an opening portion at one end and a single lid member closing the opening portion. The battery case 1 is further provided with a liquid inlet (not shown) through which an electrolyte is poured into the battery case 1, and a safe valve (not shown) that can open when the internal pressure of the battery case 1 rises beyond a predetermined pressure. The materials of the battery case 1 are not particularly limited and may be, for example, aluminum, stainless steel, and others. The outer terminals 41, 41K are connected with coupling bus bars (not shown) used to connect two or more secondary batteries 10.

The electrode body 2 is composed of the positive electrode 21 and the negative electrode 22 laminated and wound in a flat shape with separators 23 interposed therebetween, as shown in FIG. 2. As an alternative, the electrode body 2 may be composed of sheet-shaped positive electrodes 21 and sheet-shaped negative electrodes 22 stacked in a planar shape with sheet-shaped separators 23 interposed therebetween. The positive electrode 21 includes an active material coated portion 212 in which an electrode foil 21K is coated with active material KT1 and an active material uncoated portion 211 in which one end portion 21K1 of the electrode foil 21K is not coated with the active material KT1. Similarly, the negative electrode 22 includes an active material coated portion 222 in which an electrode foil 22K is coated with active material KT2 and an active material uncoated portion 221 in which one end portion 22K1 of the electrode foil 22K is not coated with the active material KT2. The active material uncoated portion 211 of the positive electrode 21 and

the active material uncoated portion 221 of the negative electrode 22 are arranged on opposite sides in the long-side direction, i.e., the direction X. The active material coated portion 212 is formed in the other end portion 21K2 and a middle portion 21K3 of the electrode foil 21K. The active material coated portion 222 is formed in the other end portion 22K2 and a middle portion 22K3 of the electrode foil 22K. As shown in FIG. 1, the active material uncoated portion 221 of the negative electrode 22 is electrically connected to the inner terminal 42 of the current collector terminal 4 provided with the current interrupt mechanism 4S. The active material uncoated portion 211 of the positive electrode 21 is electrically connected to the inner terminal 42 of the current collector terminal 4 that is the fixed terminal 4K.

In a lithium ion secondary battery, which is one example of the secondary battery 10 in the embodiment, the electrode foil 21K of the positive electrode 21 may be for example an aluminum foil, and the active material KT1 applied thereon may be for example lithium transition metal oxide (LiNi_{1/3}Co_{1/3}Mn_{1/3}, LiNiO₂, etc.). The electrode foil 22K of the negative electrode 22 may be for example a copper foil, and the active material KT2 applied thereon may be for example black carbon, hard carbon, soft carbon, etc. The separators 23 may be for example porous sheets made of polypropylene resin, polyethylene resin, etc. The electrolyte may be a well-known non-aqueous electrolyte. The current collector terminal 4 for a positive electrode is made of aluminum, for example. The current collector terminal 4 for a negative electrode is made of copper, for example.

As described above, the secondary battery 10 in the embodiment needs only include the current collector terminal 4 provided with the current interrupt mechanism 4S configured to separate the outer terminal 41 and the inner terminal 42 from each other into a de-energized relationship by the biasing force of the spring member 43 biasing the outer terminal 41 or/and the inner terminal 42 when the battery temperature rises above the predetermined temperature. Therefore, various forms may be achieved depending on the configurations of the outer terminals 41, inner terminals 42, spring member 43, and others. Typical examples of the various forms of the secondary battery 10 will be described below with a focus on the current interrupt mechanism 4S. In each of the following examples, identical or similar parts to the those mentioned above are assigned the same reference signs, and basically their explanations are omitted.

### First Example

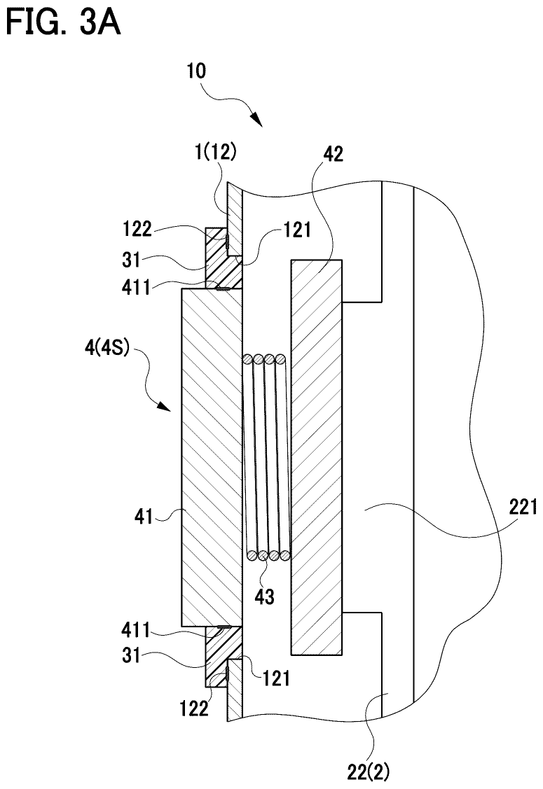

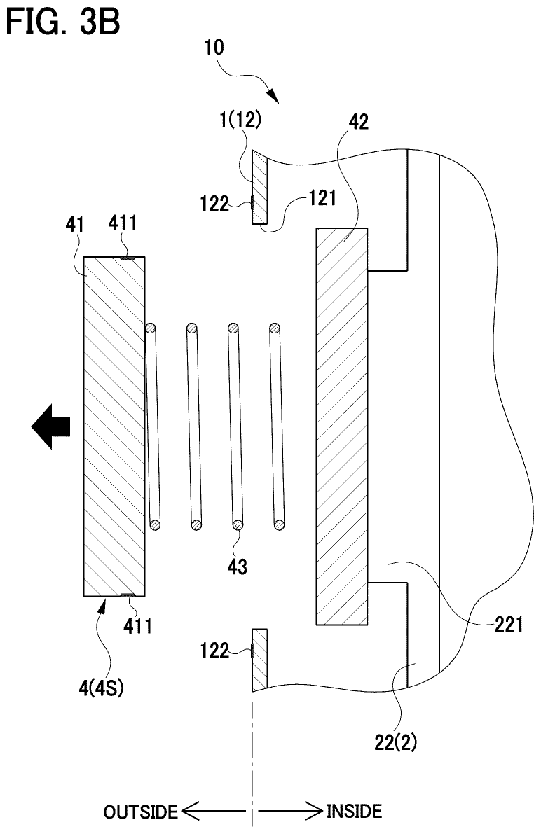

FIG. 3A is an enlarged cross-sectional view of a current interrupt mechanism in a secondary battery of a first example, showing a section A in FIG. 1. FIG. 3B is an enlarged cross-sectional view showing an activated state of the current interrupt mechanism shown in FIG. 3A. As shown in FIGS. 3A and 3B, in the secondary battery 10 of the first example, the current interrupt mechanism 4S is configured such that the outer terminal 41 is caused to move toward battery outside by the biasing force of the spring member 43 when the insulating resin member 31 melts or softens due to a battery temperature rise above a predetermined temperature, so that the outer terminal 41 and the inner terminal 42 are placed in a de-energized state. A bonding portion of the outer terminal 41 to the insulating resin member 31 and a bonding portion of the lid member 12 to the insulating resin member 31 may be formed with ring band-like roughened surfaces 411 and 122, respectively, each having an arithmetic mean roughness of 30 to 500 nm, to ensure watertightness with the insulating resin member 31.

This current interrupt mechanism 4S is provided with the compressed spring member 43 between the outer terminal 41 and the inner terminal 42. The spring member 43 is formed of a conductive spring member. This spring member 43 may be a clad member consisting of a coiled spring material coated with highly conductive metal (e.g., copper). In this example, the spring member 43 is joined to only the outer terminal 41. Accordingly, when the outer terminal 41 and the spring member 43 move together toward battery outside, i.e., outward from the battery case 1, and the spring member 43 separates from the inner terminal 42, as shown in FIG. 3B, the outer terminal 41 and the inner terminal 42 are brought into a de-energized state. As an alternative, the spring member 43 may be joined to only the inner terminal 42. In this case, when the outer terminal 41 moves alone toward the battery outside and the spring member 43 separates from the outer terminal 41, the outer terminal 41 and the inner terminal 42 are de-energized.

In the above case, when the battery temperature rises to the melting point of the insulating resin member 31 (e.g., about 290° C. for the insulating resin member 31 made of PPS resin) or a softening temperature (e.g., about 270° C. to 280° C.) close to the melting point, causing the insulating resin member 31 to melt or soften, the outer terminal 41 and the inner terminal 42 are separated from each other by the biasing force of the spring member 43 and become de-energized. Further, since the outer terminal 41 moves in a direction to separate from the inner terminal 42 with respect to the battery case 1, i.e., moves toward the battery outside, there is no need for extra space inside the battery case 1, resulting in an increased volumetric efficiency of the secondary battery 10. Consequently, quick current interrupt is enabled as the temperature rises while ensuring a high volumetric efficiency of the secondary battery 10, so that a highly safe secondary battery 10 can be achieved.

The secondary battery 10 with the compressed spring member 43 interposed between the outer terminal 41 and the inner terminal 42 may be assembled by, for example, the following procedure. The outer terminals 41, 41K and the corresponding lid members 12 are fixed to the insulating resin members 31 by insert-molding. The inner terminals 42 and the electrode body 2 are joined by welding, for example. Thereafter, the spring member 43 is held between the outer terminal 41 and the inner terminal 42, and these terminals 41 and 42 are temporarily joined to each other by bolts or the like while the spring member 43 is compressed therebetween. Then, the outer terminal 41 and the spring member are connected by a fixing member (not shown). Further, the electrode body 2 temporarily joined with the one lid member 12 is inserted, from the inner terminal 42 on the fixed terminal 4K side, into the case body 11. Each of the lid members 12 is welded to the case body 11 to close the opening portion 111. Finally, the bolts that temporarily join the outer terminal 41 and the inner terminal 42 on the current interrupt mechanism 4S side are removed, and the outer terminal 41K on the fixed terminal 4K side and the inner terminal 42 are connected to each other by bolts or the like. Thus, the secondary battery 10 of this example can be assembled by the above procedure. When a bus bar is connected to the outer terminal 41, this bus bar has to be deformable as the outer terminal 41 moves toward the battery outside.

### Second Example

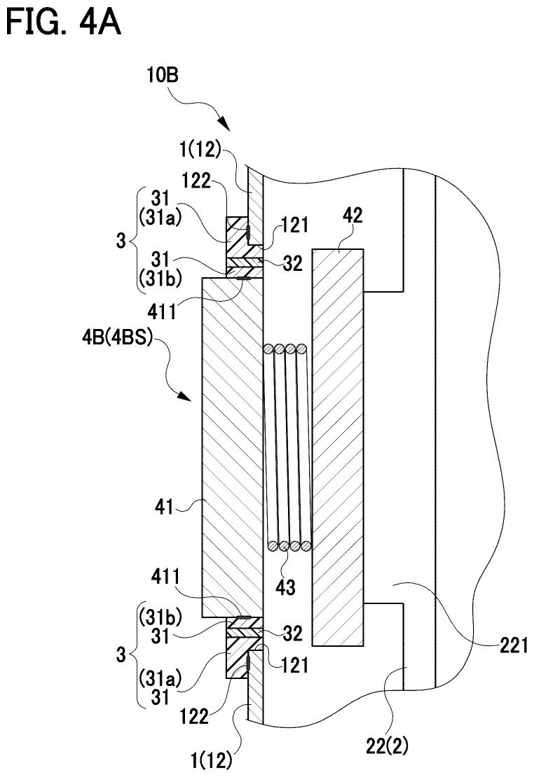

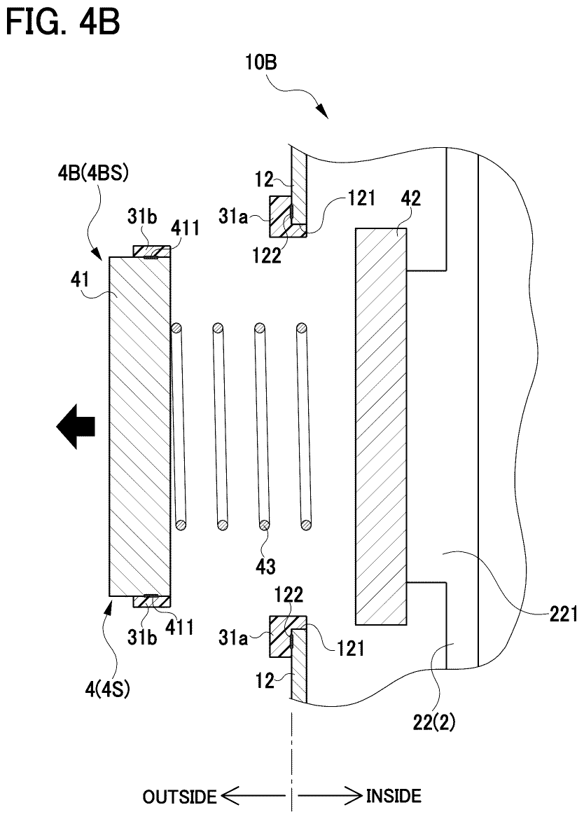

FIG. 4A is an enlarged cross-sectional view of a current interrupt mechanism in a secondary battery of a second example, showing the section A in FIG. 1. FIG. 4B is an enlarged cross-sectional view showing an activated state of the current interrupt mechanism shown in FIG. 4A. In a secondary battery 10B of the second example, as shown in FIGS. 4A and 4B, the outer terminal 41 is fixed to the battery case 1 via a layered insulating resin member 3 including a low-melting point resin member 32 as an intermediate layer of the insulating resin member 31 composed of a first insulating resin member 31a and a second insulating resin member 31b. The low-melting point resin member 32 has a lower melting point than a melting point of the insulating resin member 31. Further, in the secondary battery 10B of the second example, a current collector terminal 4B is provided with a current interrupt mechanism 4BS configured such that the outer terminal 41 is caused to move toward battery outside by the biasing force of the spring member 43 when the low-melting point resin member 32 melts or softens due to a battery temperature rise above a predetermined temperature, so that the outer terminal 41 and the inner terminal 42 are placed in a de-energized state.

Specifically, the layered insulating resin member 3 includes the low-melting point resin member 32 having a ring shape with a predetermined thickness, which is located as the intermediate layer between the first insulating resin member 31 (31a) fixed to the lid member 12 and the second insulating resin member 31 (31b) fixed to the outer terminal 41. The first insulating resin member 31 (31a) and the second insulating resin member 31 (31b) may be made of, for example, polyphenylene sulfide (PPS) resin, and the low-melting point resin member 32 may be made of, for example, polypropylene (PP) resin.

In the above case, when the battery temperature rises to the melting point of the low-melting point resin member 32 (e.g., about 170° C. for the low-melting point resin member 32 made of PP resin) or a softening temperature (e.g., about 150° C. to 160° C.) close to the melting point, causing the low-melting point resin member 32 to melt or soften, the outer terminal 41 fixed to the battery case 1 (the lid member 12) is moved in a direction to separate from the inner terminal 42, i.e., toward the battery outside, by the biasing force of the spring member 43, thereby cutting off a battery current, as shown in FIG. 4B. This configuration can interrupt the battery current at a lower battery temperature without waiting until the battery temperature rises to the melting point of the insulating resin member 31 (31a, 31b). In this case, furthermore, the outer terminal 41 is moved in the direction to separate from the inner terminal 42 with respect to the battery case 1, i.e., toward the battery outside. Accordingly, there is no need to ensure extra space in the battery case 1, and the volumetric efficiency of the secondary battery 10B can enhanced.

A bonding portion of the outer terminal 41 to the second insulating resin member 31b and a bonding portion of the lid member 12 to the first insulating resin member 31a may be formed with ring band-like roughened surfaces 411 and 122, respectively, each having an arithmetic mean roughness of 30 to 500 nm, to ensure watertightness with the insulating resin members 31a and 31b. This current interrupt mechanism 4BS is provided with the compressed spring member 43 between the outer terminal 41 and the inner terminal 42. The spring member 43 is formed of a conductive spring member. The secondary battery 10B of this example with the compressed spring member 43 interposed between the outer terminal 41 and the inner terminal 42 may be assembled, for example, in the same procedure as that in the first example.

### Third Example

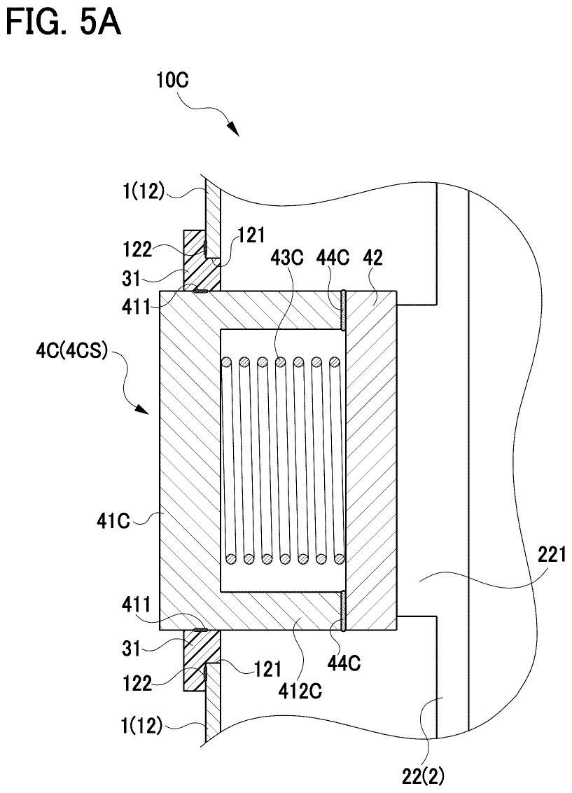

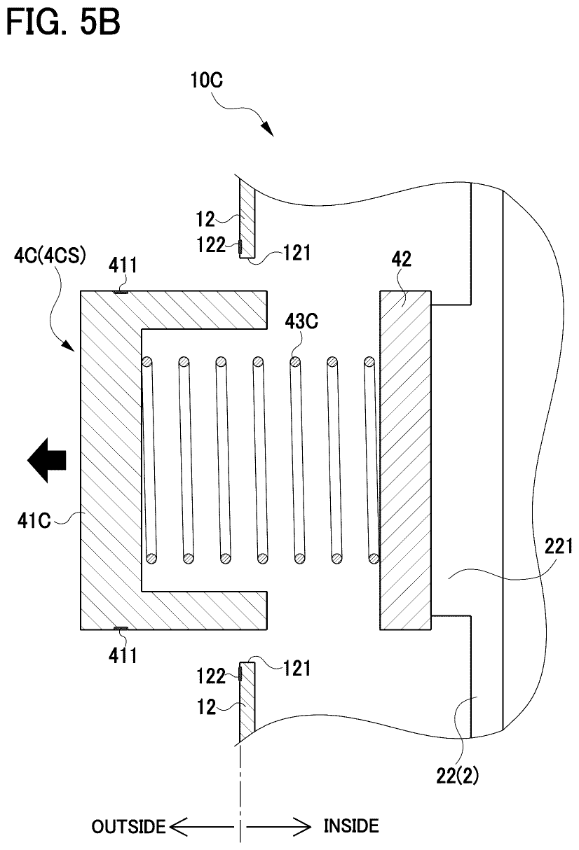

FIG. 5A is an enlarged cross-sectional view of a current interrupt mechanism in a secondary battery of a third example, showing the section A in FIG. 1. FIG. 5B is an enlarged cross-sectional view showing an activated state of the current interrupt mechanism shown in FIG. 5A. In a secondary battery 10C of the third example, as shown in FIGS. 5A, 5B, a current collector terminal 4C is provided with a current interrupt mechanism 4CS configured such that an outer terminal 41C is caused to move toward battery outside by the biasing force of a spring member 43C when the insulating resin member 31 melts or softens due to a battery temperature rise above a predetermined temperature, so that the outer terminal 41C and the inner terminal 42 are de-energized. A bonding portion of the outer terminal 41C to the insulating resin member 31 and a bonding portion of the lid member 12 to the insulating resin member 31 may be formed with ring band-like roughened surfaces 411 and 122, respectively, each having an arithmetic mean roughness of 30 to 500 nm, to ensure watertightness with the insulating resin members 31.

This current interrupt mechanism 4CS is provided with the compressed spring member 43C between the outer terminal 41C and the inner terminal 42. The spring member 43C is formed of a non-conductive spring member. This non-conductive spring member 43C may be a clad member consisting of, for example, a coiled spring material coated with an insulating material. The spring member 43C of this example is not conductive, but is not limited thereto, and may be a conductive spring member as long as an insulating sheet is disposed between the spring member 43C and the outer terminal 41C or the inner terminal 42. In this example, the spring member 43C is interposed between the outer terminal 41C and the inner terminal 42; however, the location of the spring member 43C is not limited thereto and may be between the outer terminal 41C and the lid member 12. In this case, when the spring member 43C is a conductive spring member, an insulating sheet also has to be interposed between the spring member 43C and the outer terminal 41C or the lid member 12.

The outer terminal 41C is formed with a hat-like cross-section having a space for holding the spring member 43C, and includes a leg part 412C joined to the inner terminal 42. The leg part 412C and the inner terminal 42 are joined by a metal joining member 44C that can melt at a lower temperature than the melting point of the insulating resin member 31. For example, when the insulating resin member 31 is made of PPS resin, the metal joining member 44C is lead-free solder with a melting point of about 217° C. or lead-containing solder with a melting point of about 183° C. The metal joining member 44C may also be an adhesive as long as it is a conductive joining member.

In the above case, when the battery temperature rises to the melting point of the insulating resin member 31 (e.g., about 290° C. for the insulating resin member 31 made of PPS resin) or a softening temperature (e.g., about 270° C. to 280° C.) close to the melting point, causing the metal joining member 44C to melt and the insulating resin member 31 to melt or soften, the outer terminal 41C and the inner terminal 42 are separated from each other by the biasing force of the spring member 43 and thus de-energized. Further, the outer terminal 41C moves in the direction to separate from the inner terminal 42 with respect to the battery case 1, i.e., moves toward the battery outside, there is no need for extra space in the battery case 1, resulting in an increased volumetric efficiency of the secondary battery 10C. Consequently, quick current interrupt is enabled as the temperature rises while ensuring a high volumetric efficiency of the secondary battery 10C, so that a highly safe secondary battery 10C can be achieved.

The secondary battery 10C with the compressed spring member 43C between the outer terminal 41C and the inner terminal 42 may be assembled by, for example, the following procedure. The outer terminals 41C, 41K and the corresponding lid members 12 are fixed to the insulating resin members 31 by insert-molding. The inner terminals 42 and the electrode body 2 are joined by welding, for example. Thereafter, the compressed spring member 43C is inserted between the outer terminal 41C and the inner terminal 42, and the leg part 412C of the outer terminal and the inner terminal 42 are joined by the metal joining member 44C. Then, the electrode body 2 is inserted, from the inner terminal 42 on the fixed terminal 4K side, into the case body 11. Each of the lid members 12 is welded to the case body 11 to close the opening portion 111. Finally, the outer terminal 41K of the fixed terminal 4K and the inner terminal 42 are connected to each other by bolts or the like. Thus, the secondary battery 10C of this example can be assembled by the above procedure. When a bus bar is connected to the outer terminal 41C, the bus bar has to be deformable as the outer terminal 41C moves outward from the battery.

### Fourth Example

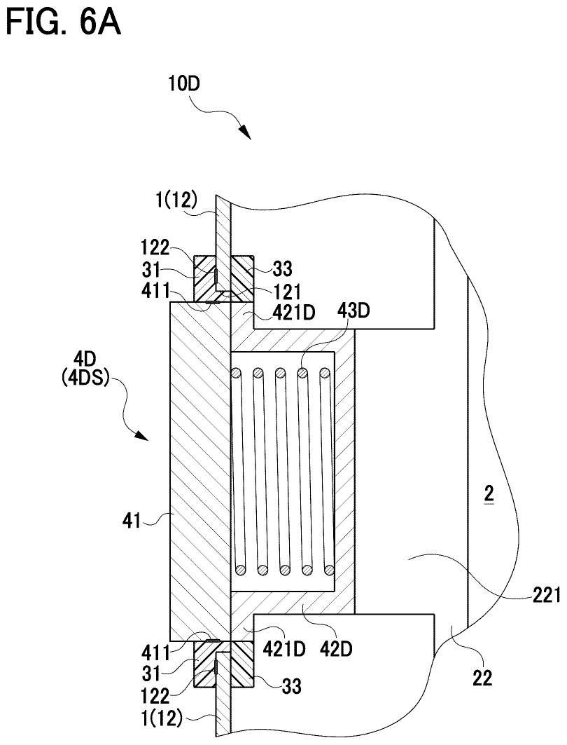

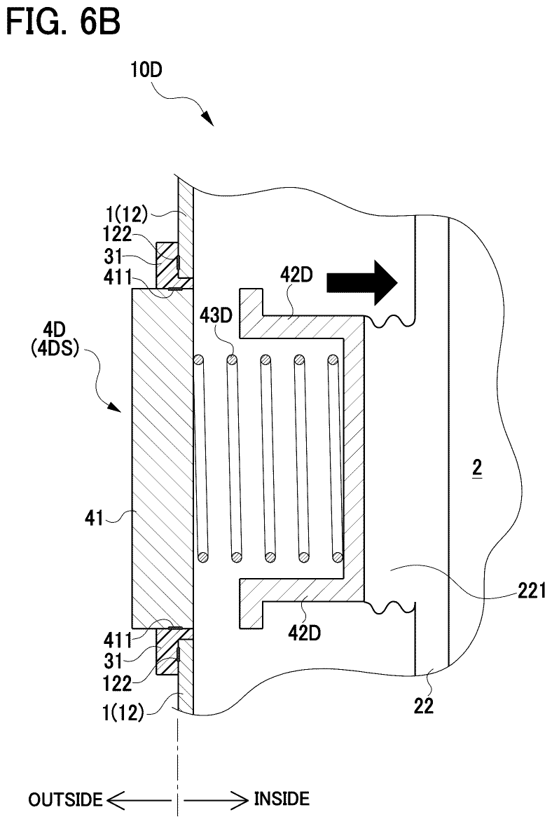

FIG. 6A is an enlarged cross-sectional view of a current interrupt mechanism in a secondary battery of a fourth example, showing the section A in FIG. 1. FIG. 6B is an enlarged cross-sectional view showing an activated state of the current interrupt mechanism shown in FIG. 6A. In a secondary battery 10D of the fourth example, as shown in FIG. 6A, an inner terminal 42D is fixed to the battery case 1 or the insulating resin member 31 via a low-melting resin member 33 having a lower melting point than the melting point of the insulating resin member 31. Further, in the secondary battery 10D of the fourth example, a current collector terminal 4D is provided with a current interrupt mechanism 4DS configured such that the inner terminal 42D is caused to move toward battery inside by the biasing force of a spring member 43D when the low-melting resin member 33 melts or softens due to a battery temperature rise above a predetermined temperature, as shown in FIG. 6B, so that the outer terminal 41 and the inner terminal 42 are placed in a de-energized state. A bonding portion of the outer terminal 41 to the insulating resin member 31 and a bonding portion of the lid member 12 to the insulating resin member 31 may be formed with ring band-like roughened surfaces 411 and 122, respectively, each having an arithmetic mean roughness of 30 to 500 nm, to ensure watertightness with the insulating resin members 31.

This current interrupt mechanism 4DS is provided with the compressed spring member 43D between the outer terminal 41 and the inner terminal 42D. The spring member 43D is formed of a non-conductive spring member. This non-conductive spring member 43D may be a clad member consisting of, for example, a coiled spring material coated with an insulating material. The spring member 43D of this example is not conductive, but is not limited thereto, and may be a conductive spring member as long as an insulating sheet is interposed between the spring member 43D and the outer terminal 41 or the inner terminal 42D. In this example, the spring member 43D is interposed between the outer terminal 41 and the inner terminal 42D; however, the location of the spring member 43D is not limited thereto and may be between the inner terminal 42D and the lid member 12. In this case, when the spring member 43D is a conductive spring member, an insulating sheet also has to be interposed between the spring member 43D and the inner terminal 42D or the lid member 12.

The inner terminal 42D is formed with a hat-like cross-section having a space for holding the spring member 43D, and includes a flange part 421D placed in contact with the outer terminal 41. The flange part 421D is fixed to the lid member 12 and the insulating resin member 31 via the low-melting resin member 33 having a lower melting point than that of the insulating resin member 31. The insulating resin member 31 may be made of, for example, polyphenylene sulfide (PPS) resin, and the low-melting resin member 33 may be made of, for example, polypropylene (PP) resin.

In the above case, when the battery temperature rises to the melting point of the low-melting resin member 33 (e.g., about 170° C. for the low-melting resin member 33 made of PP resin) or a softening temperature (e.g., about 150° C. to 160° C.) close to the melting point, the inner terminal 42D fixed to the lid member 12 and the insulating resin member 31 is moved in the direction to separate from the outer terminal 41, i.e., toward battery inside, by the biasing force of the spring member 43D, thereby interrupting a battery current. When the inner terminal 42D moves toward the battery inside, the active material uncoated portion 221 of the negative electrode 22 is caused to bend or buckle. This configuration can interrupt the battery current at a lower battery temperature without waiting until the battery temperature rises to the melting point of the insulating resin members 31. In this case, furthermore, the inner terminal 42D is moved in the direction to separate from the outer terminal 41, i.e., toward the battery inside, and the outer terminal 41 is not moved with respect to the battery case 1. Accordingly, even when a bus bar or the like is connected to the outer terminal 41, the bus bar needs not be deformable.

The secondary battery 10D of this example with the compressed spring member 43D interposed between the outer terminal 41 and the inner terminal 42D may be assembled by, for example, the following procedure. The outer terminals 41, 41K and the lid members 12 are fixed to the insulating resin members 31 by insert-molding. The inner terminals 42D and the electrode body 2 are joined by welding, for example. Thereafter, the compressed spring member 43D is inserted between the outer terminal 41 and the inner terminal 42D, and these terminals 41 and 42D are temporarily joined to each other. In this state, the inner terminal 42D and the lid member 12 are fixed to the low-melting resin member 33 by insert-molding. Then, the electrode body 2 is inserted, from the inner terminal 42 on the fixed terminal 4K side, into the case body 11, and each of the lid members 12 is welded to the case body 11 to close the opening portion 111. Finally, the outer terminal 41K of the fixed terminal 4K and the inner terminal 42 are connected to each other by bolts or the like. Thus, the secondary battery 10D of this example can be assembled by the above procedure.

### Fifth Example

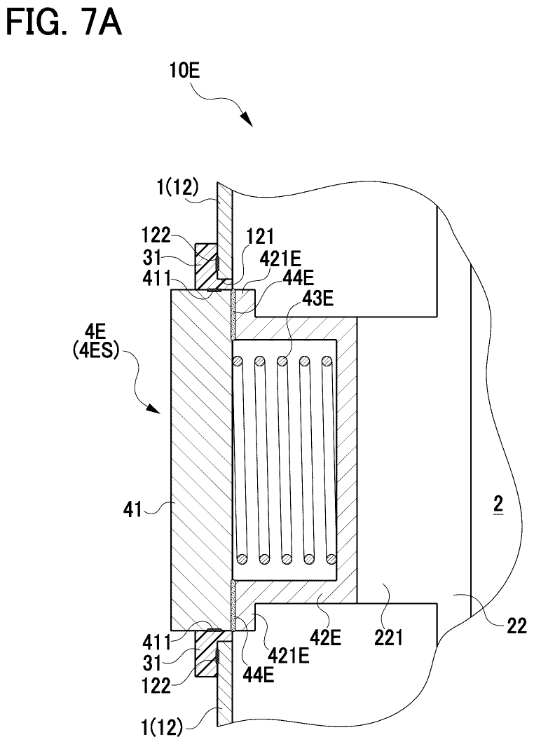

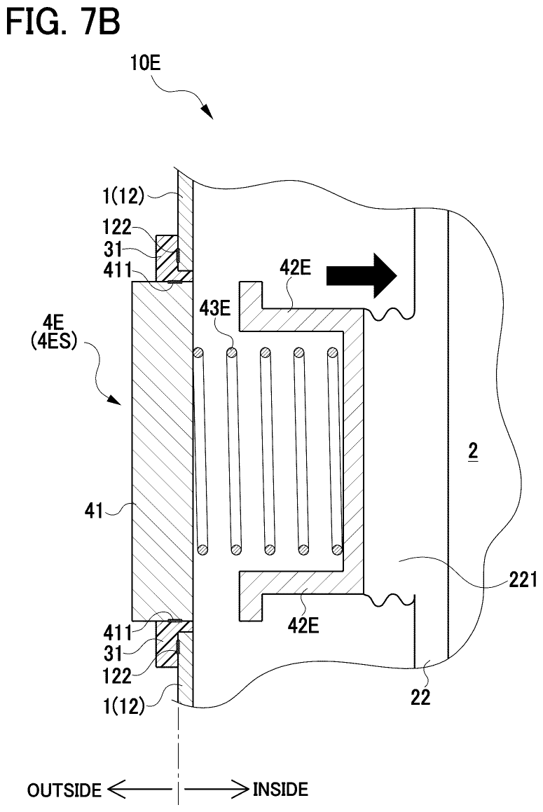

FIG. 7A is an enlarged cross-sectional view of a current interrupt mechanism in a secondary battery of a fifth example, showing the section A in FIG. 1. FIG. 7B is an enlarged cross-sectional view showing an activated state of the current interrupt mechanism shown in FIG. 7A. In a secondary battery 10E of the fifth example, as shown in FIG. 7A, an inner terminal 42E is joined to the outer terminal 41 via a low-melting point joining member 44E having a lower melting point than the melting point of the insulating resin member 31. Further, in the secondary battery 10E of the fifth example, a current collector terminal 4E is provided with a current interrupt mechanism 4ES configured such that the inner terminal 42E is caused to move toward the battery inside by the biasing force of a spring member 43E when the low-melting point joining member 44E melts or softens due to a battery temperature rise above a predetermined temperature, as shown in FIG. 7B, so that the outer terminal 41 and the inner terminal 42E are placed in a de-energized state. A bonding portion of the outer terminal 41 to the insulating resin member 31 and a bonding portion of the lid member 12 to the insulating resin member 31 may be formed with ring band-like roughened surfaces 411 and 122, respectively, each having an arithmetic mean roughness of 30 to 500 nm, to ensure watertightness with the insulating resin members 31.

This current interrupt mechanism 4ES is provided with the compressed spring member 43E between the outer terminal 41 and the inner terminal 42E. The spring member 43E is formed of a non-conductive spring member. This spring member 43E may be a clad member consisting of, for example, a coiled spring material coated with an insulating material. The spring member 43E of this example is not conductive, but is not limited thereto, and may be a conductive spring member as long as an insulating sheet is interposed between the spring member 43E and the outer terminal 41 or the inner terminal 42E. In this case, when the spring member 43E is a conductive spring member, an insulating sheet also has to be interposed between the spring member 43E and the inner terminal 42E or the lid member 12.

The inner terminal 42E is formed with a hat-like cross-section having a space for holding the spring member 43E, and includes a flange part 421E joined to the outer terminal 41. The flange part 421E is joined to the outer terminal 41 via the low-melting point joining member 44E having a lower melting point than that of the insulating resin member 31. For example, when the insulating resin member 31 is made of PPS resin, the low-melting point joining member 44E is lead-free solder with a melting point of about 217° C. or lead-containing solder with a melting point of about 183° C. The low-melting point joining member 44E may also be an adhesive as long as it is a conductive joining member.

In the above case, when the battery temperature rises to the melting point of the low-melting point joining member 44E (e.g., for the low-melting point joining member 44E made of lead-free solder, about 217° C. that is a melting point of the lead-free solder) or a softening temperature (e.g., about 210° C. to 215° C.) close to the melting point, the inner terminal 42E joined to the outer terminal 41 is moved in the direction to separate from the outer terminal 41, i.e., toward battery inside, by the biasing force of the spring member 43E, thereby interrupting a battery current. When the inner terminal 42E moves toward the battery inside, the active material uncoated portion 221 of the negative electrode 22 is caused to bend or buckle. This configuration can interrupt the battery current at a lower battery temperature without waiting until the battery temperature rises to the melting point of the insulating resin member 31. In this case, furthermore, the inner terminal 42E is moved in the direction to separate from the outer terminal 41, i.e., toward the battery inside, and the outer terminal 41 is not moved with respect to the battery case 1. Accordingly, even when a bus bar or the like is connected to the outer terminal 41, the bus bar needs not be deformable.

The secondary battery 10E of this example with the compressed spring member 43E between the outer terminal 41 and the inner terminal 42E may be assembled by, for example, the following procedure. The outer terminals 41, 41K and the lid members 12 are fixed to the insulating resin members 31 by insert-molding. The inner terminals 42E and the electrode body 2 are joined by welding, for example. Thereafter, the compressed spring member 43E is inserted between the outer terminal 41 and the inner terminal 42E, and these terminals 41 and 42E are joined to each other via the low-melting point joining member 44E. Then, the electrode body 2 is inserted, from the inner terminal 42 on the fixed terminal 4K side, into the case body 11, and each of the lid members 12 is welded to the case body 11 to close the opening portion 111. Finally, the outer terminal 41K of the fixed terminal 4K and the inner terminal 42 are connected to each other by bolts or the like. Thus, the secondary battery 10E of this example can be assembled by the above procedure.

### Sixth Example

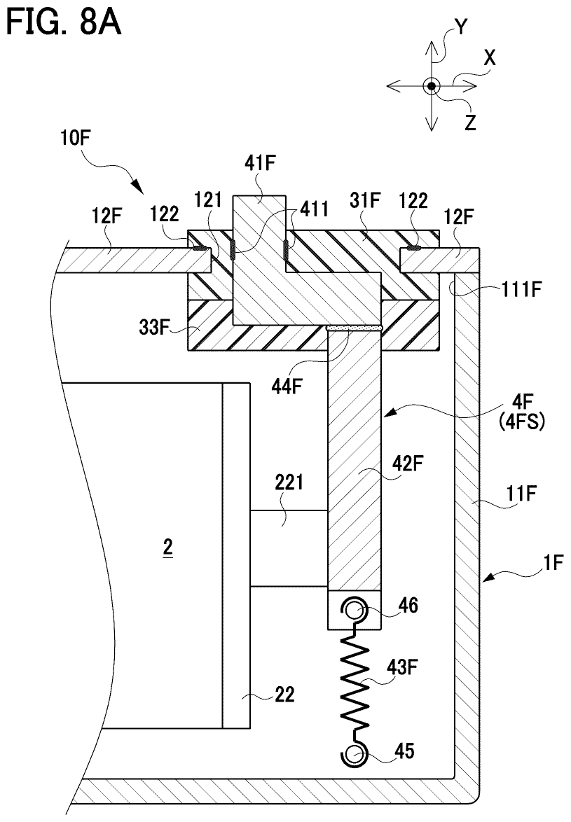

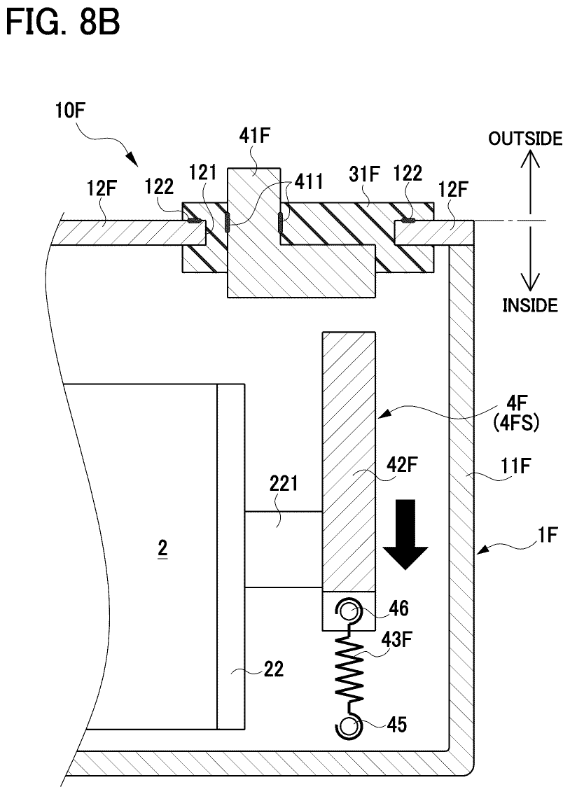

FIG. 8A is an enlarged cross-sectional view of a current interrupt mechanism in a secondary battery of a sixth example according to another aspect of the embodiment. FIG. 8B is an enlarged cross-sectional view showing an activated state of the current interrupt mechanism shown in FIG. 8A. In FIG. 8A, the direction X indicates a long-side direction of a battery case, the direction Y indicates a vertical direction of the battery case, and the direction Z indicates a width direction (i.e., a short-side direction) of the battery case. As shown in FIGS. 8A and 8B, a secondary battery 10F of the sixth example is provided with a battery case 1F, an electrode body 2 housed in the battery case 1F (i.e., a case body 11F with an opening portion 111F at one end), and a current collector terminal 4F. This current collector terminal 4F includes an outer terminal 41F inserted in the terminal through hole 121 of the battery case 1F (i.e., a lid member 12F) and fixed to the battery case 1F (the lid member 12F) via an insulating resin member 31F, and an inner terminal 42F formed to be energized to the outer terminal 41F and connected to the electrode body 2. The current collector terminal 4F is further provided with a current interrupt mechanism 4FS including a spring member 43F that biases the inner terminal 42F and being configured such that, when the battery temperature rises above a predetermined temperature, the outer terminal 41F and the inner terminal 42F are separated from each other into a de-energized state by the biasing force of the spring member 43F.

The inner terminal 42F is joined to the outer terminal 41F by a low-melting point joining member 44F having a lower melting point than that of the insulating resin member 31F. The current interrupt mechanism 4FS is configured such that, when the low-melting point joining member 44F melts or softens due to a battery temperature rise above a predetermined temperature, the inner terminal 42F is caused to move toward the battery inside by the biasing force of the spring member 43F, separating from the outer terminal 41F, as shown in FIG. 8B, so that the outer terminal 41F and the inner terminal 42F are placed in a de-energized state. A bonding portion of the outer terminal 41F to the insulating resin member 31F and a bonding portion of the lid member 12F to the insulating resin member 31F may be formed with ring band-like roughened surfaces 411 and 122, respectively, each having an arithmetic mean roughness of 30 to 500 nm, to ensure watertightness with the insulating resin member 31F.

This current interrupt mechanism 4FS is provided with the spring member 43F for tension between the battery case 1F (the case body 11F) and the inner terminal 42F. Specifically, one end of this spring member 43F engages a lock pin 45 fixed to the inner surface of the case body 11F and the other end engages a lock pin 46 fixed to the lower end portion of the inner terminal 42F. The spring member 43F is formed of a non-conductive spring member. This non-conductive spring member 43F may be a clad member consisting of, for example, a coiled spring material coated with an insulating material. The spring member 43F of this example is not conductive, but is not limited thereto, and may be a conductive spring member as long as the lock pins 45 and 46 are insulating pins to lock (engage) the spring member 43F to the battery case 1F (the case body 11F) or the inner terminal 42F.

The inner terminal 42F is joined to the outer terminal 41F by the low-melting point joining member 44F having a lower melting point than that of the insulating resin member 31F. For example, when the insulating resin member 31F is made of PPS resin, the inner terminal 42F is lead-free solder with a melting point of about 217° C. or lead-containing solder with a melting point of about 183° C. The low-melting point joining member 44F may also be an adhesive as long as it is a conductive joining member. In this example, the lower end portion of the outer terminal 41F and the upper end portion of the inner terminal 42F are surrounded by a low-melting point resin member 33F (e.g., PP resin) having a lower melting point than that of the low-melting point joining member 44F. The low-melting point resin member 33F is effective in protecting a joint between the outer terminal 41F and the inner terminal 42F, but is not indispensable.

In the above case, when the battery temperature rises to the melting point of the low-melting point joining member 44F (e.g., for the low-melting point joining member 44F made of lead-free solder, about 217° C. that is a melting point of lead-free solder) or a softening temperature (e.g., about 210° C. to 215° C.) close to the melting point, causing the low-melting point joining members 44F and the low-melting point resin member 33F to melt or soften, the inner terminal 42F joined to the outer terminal 41F is moved in the direction to separate from the outer terminal 41F, i.e., toward the battery inside, by the biasing force of the spring member 43F, thereby interrupting battery current. This configuration can interrupt the battery current at a lower battery temperature without until the battery temperature rises to the melting point of the insulating resin member 31F. In this case, furthermore, the inner terminal 42F is moved in the direction to separate from the outer terminal 41F, i.e., toward the battery inside, and the outer terminal 41F is not moved with respect to the battery case 1F. Accordingly, even when a bus bar or the like is connected to the outer terminal 41F, the bus bar needs not be deformable.

The battery 10F of this example with the tension spring member 43F between the battery case 1F (the case body 11F) and the inner terminal 42F may be assembled by, for example, the following procedure. The outer terminal 41F and the inner terminal 42F are joined by the low-melting point joining member 44F. The outer terminal 41F, the inner terminal 42F, and the lid member 12F are fixed to the insulating resin member 31F by insert-molding. If necessary, after the insulating resin member 31F is solidified, those terminals 41F and 42F are fixed to the low-melting point resin member 33F by insert-molding. The inner terminal 42F and the electrode body 2 are joined by welding, for example. With the spring member 43F engaged with the case body 11F and the inner terminal 42F, the electrode body 2 is inserted into the case body 11F. The lid member 12F and the case body 11F are then welded to close the opening portion 111. Thus, the battery 10F of this example can be assembled by the above procedure.

The foregoing embodiments are mere examples and give no limitation to the disclosure. The disclosure may be embodied in other specific forms without departing from the essential characteristics thereof.

### REFERENCE SIGNS LIST

1 Battery case
2 Electrode body
3 Insulating resin member
4 Current collector terminal
4S, 4BS, 4CS, 4DS Current interruption mechanism
4ES, 4FS Current interruption mechanism
10, 10B, 10C, 10D Secondary battery
10E, 10F Secondary battery
31, 31F Insulating resin member
32 Low-melting point resin member
33 Low-melting resin member
41, 41C, 41F Outer terminal
42, 42D, 42E, 42F Inner terminal
43, 43C, 43D, 43E Spring member
43F Spring member
4E, 44F Low-melting point joining member
121 Terminal through hole

What is claimed is:

1. A secondary battery comprising:
a battery case including a terminal through hole;
an electrode body housed in the battery case; and
a current collector terminal including:
an outer terminal inserted in the terminal through hole of the battery case and fixed to the battery case via an insulating resin member; and
an inner terminal connected to the electrode body and formed to be energized to the outer terminal,
wherein the current collector terminal is provided with a current interrupt mechanism including a spring member that biases the outer terminal or/and the inner terminal, the current interrupt mechanism being configured such that, when a battery temperature rises above a predetermined temperature, the outer terminal and the inner terminal are separated from each other into a de-energized state by a biasing force of the spring member.

2. The secondary battery according to claim 1, wherein the current interrupt mechanism is configured such that, when the battery temperature rises above the predetermined temperature and the insulating resin member melts or softens, the outer terminal is caused to move toward battery outside by the biasing force of the spring member, so that the outer terminal and the inner terminal are placed in the de-energized state.

3. The secondary battery according to claim 1, wherein
the insulating resin member is a layered insulating resin member including a low-melting point resin member as an intermediate layer of the insulating resin member, the low-melting point resin member having a lower melting point than a melting point of the insulating resin member, and the outer terminal is fixed to the battery case via the layered insulating resin member, and
the current interrupt mechanism is configured such that, when the low-melting point resin member melts or softens, the outer terminal is caused to move toward battery outside by the biasing force of the spring member, so that the outer terminal and the inner terminal are placed in the de-energized state.

4. The secondary battery according to claim 1, wherein
the inner terminal is fixed to either the battery case or the insulating resin member via a low-melting resin member having a lower melting point than the insulating resin member, and
the current interrupt mechanism is configured such that, when the low-melting resin member melts or softens, the inner terminal is caused to move toward battery inside by the biasing force of the spring member, so that the outer terminal and the inner terminal are placed in the de-energized state.

5. The secondary battery according to claim 1, wherein
the inner terminal is joined to the outer terminal with a low-melting point joining member having a lower melting point than a melting point of the insulating resin member, and
the current interrupt mechanism is configured such that, when the low-melting point joining member melts or softens, the inner terminal is caused to move toward battery inside by the biasing force of the spring member, so that the outer terminal and the inner terminal are placed in the de-energized state.
